(19) United States
(12) Patent Application Publication
(10) Pub. No.: US 2026/0105347 A1
(43) Pub. Date: Apr. 16, 2026

(54) MULTI-DIMENSIONAL EMPIRICALLY ADAPTED DYNAMICAL DECOUPLING FOR DYNAMIC CIRCUITS

(71) Applicant: International Business Machines Corporation, Armonk, NY (US)

(72) Inventors: Helena Zhang, White Plains, NY (US); Christopher Tong, Boston, MA (US); Swarnadeep Majumder, Durham, NC (US); Derek Wang, New York, NY (US); Luke Colin Gene Govia, Sunnyvale, CA (US); Bibek Pokharel, San Jose, CA (US)

(21) Appl. No.: 18/914,729

(22) Filed: Oct. 14, 2024

(51) Int. Cl. G06N 10/70; G06N 10/20; G06N 10/40

(52) U.S. Cl. CPC G06N 10/70; G06N 10/20; G06N 10/40

(57) ABSTRACT

One or more systems, devices, computer program products and/or computer-implemented methods of use provided herein relate to multi-dimensional empirically adapted dynamical decoupling for dynamic circuits. For example, a system can comprise a memory that can store computer executable components and a processor that can execute at least one of the computer executable components that can obtain a graph of a quantum processor that represents qubit connectivity and collisions in the quantum processor. The computer executable components can further determine a first dynamical decoupling strategy for collision qubits. The computer executable components can further determine, based on the graph of the quantum processor, a second dynamical decoupling strategy for non-collision qubits through empirical learning. The computer executable components can further apply the first dynamical decoupling strategy and the second dynamical decoupling strategy to a quantum circuit. The computer executable components can further perform the quantum circuit on the quantum processor.

This invention was made with government support under W911NF-21-1-0002 awarded by Army Research Office (ARO). The government has certain rights to this invention.

### BACKGROUND

The subject disclosure relates to quantum error suppression and, more specifically, to multi-dimensional empirically adapted dynamical decoupling for dynamic circuits.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable multi-dimensional empirically adapted dynamical decoupling for dynamic circuits are discussed.

According to an embodiment, a system is provided. The system can comprise a memory that can store computer executable components. The system can further comprise a processor that can execute at least one of the computer executable components that can obtain a graph of a quantum processor that represents qubit connectivity and collisions in the quantum processor. The at least one of the computer executable components can further determine a first dynamical decoupling strategy for collision qubits. The at least one of the computer executable components can further determine, based on the graph of the quantum processor, a second dynamical decoupling strategy for non-collision qubits through empirical learning. The at least one of the computer executable components can further apply the first dynamical decoupling strategy and the second dynamical decoupling strategy to a quantum circuit. The at least one of the computer executable components can further perform the quantum circuit on the quantum processor.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate multi-dimensional empirically adapted dynamical decoupling for dynamic circuits in accordance with one or more embodiments described herein.

FIG. 2 illustrates a block diagram of an example, non-limiting quantum system that can at least partially facilitate multi-dimensional empirically adapted dynamical decoupling for dynamic circuits in accordance with one or more embodiments described herein.

FIG. 3 illustrates a diagram of example, non-limiting dynamic circuit in accordance with one or more embodiments described herein.

FIG. 4 illustrates diagrams of example, non-limiting genetic algorithm-based dynamical decoupling methods in accordance with one or more embodiments described herein.

FIG. 5 illustrates a flow diagram of an example, non-limiting method that can facilitate multi-dimensional empirically adapted dynamical decoupling for dynamic circuits in accordance with one or more embodiments described herein.

FIG. 6 illustrates a diagram of an example, non-limiting quantum circuit with GADD on collision qubits in accordance with one or more embodiments described herein.

FIG. 7 illustrates diagrams of an example, non-limiting device graphs associated with no collisions and unidirectional collisions in accordance with one or more embodiments described herein.

FIG. 8 illustrates diagrams of example, non-limiting device graphs associated with bidirectional collisions and multiple collisions in accordance with one or more embodiments described herein.

FIG. 9 illustrates flow diagrams of an example, non-limiting method that can facilitate coloring of a device graph with multi-dimensional GADD in accordance with one or more embodiments described herein.

FIG. 10-12 illustrate diagrams of example, non-limiting device graphs with multi-dimensional GADD in accordance with one or more embodiments described herein.

FIG. 13 illustrates flow diagrams of an example, non-limiting method that can facilitate training for multi-dimensional GADD in a parallelized manner in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute at least one of the computer executable components that can comprise obtain a graph of a quantum processor that represents qubit connectivity and collisions in the quantum processor. The at least one of the computer executable components can further determine a first dynamical decoupling strategy for collision qubits. The at least one of the computer executable components can further determine, based on the graph of the quantum processor, a second dynamical decoupling strategy for non-collision qubits through empirical learning. The at least one of the computer executable components can further apply the first dynamical decoupling strategy and the second dynamical decoupling strategy to a quantum circuit. The at least one of the computer executable components can further perform the quantum circuit on the quantum processor. Such embodiments of the system can provide a number of advantages, including providing empirical optimization of dynamical decoupling to dynamic circuits, providing error suppression of any quantum circuit on a given quantum device without additional overhead, providing scalability of empirical optimization of dynamical decoupling, and improving performance of error suppression via dynamical decoupling.

In one or more embodiments of the aforementioned system, that at least one of the computer executable components can further apply the first dynamical decoupling strategy and the second dynamical decoupling strategy to the quantum circuit based on colliding qubit properties or non-colliding qubit properties at idle gaps in the quantum circuit. Such embodiments of the system can provide the advantage of improved performance of error suppression by cancelling measurement-dependent collision errors at each idle gap in the quantum circuit.

In one or more embodiments of the aforementioned system, the at least one of the computer executable components can further populate unitary qubits that collide with a measured qubit with a set of collision sequences in the graph. Such embodiments of the system can provide a number of advantages, including generalizing multi-dimensional empirically adapted dynamical decoupling to be applicable to quantum devices with complex connectivity.

In one or more embodiments of the aforementioned system, the at least one of the computer executable components can further determine respective dynamical decoupling sequences of the non-collision qubits that that have unitary statuses are different from dynamical decoupling sequences of neighboring non-collision qubits. Such embodiments of the system can provide a number of advantages, including minimizing crosstalk in the quantum circuit.

In one or more embodiments of the aforementioned system, the at least one of the computer executable components can further determine if the graph satisfies a set of conditions based on the respective dynamical decoupling sequences of the non-collision qubits that are unitary qubits, wherein the set of conditions assert that, for any time point, unitary qubits in a collision with one or more measured qubits have corresponding collision dynamical decoupling sequences applied and unitary qubits that are not in a collision with the one or more measured qubits have distinct dynamical decoupling strategies from adjacent qubits applied. Such embodiments of the system can provide a number of advantages, including minimizing crosstalk in the quantum circuit.

In one or more embodiments of the aforementioned system, the at least one of the computer executable components can further create additional dynamical decoupling sub-strategies from the second dynamical decoupling strategy until the set of conditions are satisfied. Such embodiments of the system can provide a number of advantages, including minimizing crosstalk in the quantum circuit.

In one or more embodiments of the aforementioned system, the at least one of the computer executable components can further determine the first dynamical decoupling strategy for collision qubits based on unidirectional collisions, bidirectional collisions, or multiple collisions, wherein the first dynamical decoupling strategy consists of respective dynamical decoupling sequences for each collision qubit. Such embodiments of the system can provide a number of advantages, including improving effectiveness of error suppression via dynamical decoupling by mitigating error based on status and locations of the qubits.

In one or more embodiments of the aforementioned system, determining the first dynamical decoupling strategy or the second dynamical decoupling strategy can comprise empirically learning dynamical decoupling strategies on the quantum circuit by constructing a plurality of training circuits from the quantum circuit, wherein the dynamical decoupling strategies are applicable to any qubit pairs in the quantum circuit. Such embodiments of the system can provide a number of advantages, including parallelizing the learning process to increase processing efficiency of error suppression via dynamical decoupling.

In one or more embodiments of the aforementioned system, constructing the plurality of training circuits can comprise dividing the quantum circuit into sub-circuits; and iteratively creating the plurality of training circuits using the sub-circuits. Such embodiments of the system can provide a number of advantages, including parallelizing the learning process to increase processing efficiency of error suppression via dynamical decoupling.

In one or more embodiments of the aforementioned system, iteratively creating the plurality of training circuits using the sub-circuits can comprise identifying a subset of the sub-circuits that are qubit-dependent; assigning the subset of the sub-circuits that are qubit-dependent to a respective set of quantum registers; assigning slots in the plurality of training circuits to the sub-circuits that are qubit-dependent and the respective set of quantum registers; and assigning slots in the plurality of training circuits to sub-circuits that are qubit-independent and a first available set of quantum registers. Such embodiments of the system can provide a number of advantages, including parallelizing the learning process to increase processing efficiency of error suppression via dynamical decoupling.

In one or more embodiments of the aforementioned system, iteratively creating the plurality of training circuits using the sub-circuits can further comprise creating an additional training circuit if there are no available quantum registers in the plurality of training circuits. Such embodiments of the system can provide a number of advantages, including parallelizing the learning process to increase processing efficiency of error suppression via dynamical decoupling.

According to various embodiments, the above-described system can be implemented as a computer-implemented method or as a computer program product.

### Definitions

Scheduled quantum circuit: A scheduled quantum circuit is a quantum circuit decomposed to native operations of a quantum device that it will be executed on, with runtimes listed for all corresponding circuit operations.

Measured status: A measured status is the status of a qubit at a specific time in a scheduled circuit when it is being measured.

Unitary status: A unitary status is the status of a qubit at a specific time when it is not being measured, contrasting with a measured status.

Dynamic circuit: A dynamic circuit is a quantum circuit that contains at least one qubit that is in a measured status at any time before a final measurement at the end of the quantum circuit and mid-circuit measurements that can be used to control gates on other qubits in the quantum circuit via feedforward.

Non-dynamic circuit: A non-dynamic circuit is a quantum circuit that only contains qubits that are always in a unitary status until a final measurement at the end of the quantum circuit.

Measurement-induced control error: A measurement-induced control error is an error induced on a unitary qubit by a measurement action on a measured qubit that's caused by undesired qubit coupling to the measurement field.

Measurement-induced collision error: A measurement-induced collision error is an unwanted excitation hopping between qubits during measurement caused by AC Stark shift due to the measurement field.

Device graph: A device graph is a graph with qubits as vertices and edges that indicate pairs of qubits on which native two-qubit gates can be performed. The qubits may be multiplexed together on readout resonators.

Dynamical decoupling (DD): DD is a scalable, resource-efficient error suppression method where DD sequences comprised of pulses are applied to qubits at intervals with the goal of cancelling the effects of system-environment interactions.

DD strategy: A DD strategy is a set of DD sequences applied to idle gaps on a scheduled circuit, where the DD sequences can differ in gates and timing in each gap.

DD coloring: A DD coloring is a coloring of the device graph such that each color corresponds to a different DD sequence.

Genetic algorithm-based dynamical decoupling (GADD): GADD refers to an empirically optimized DD strategy on real hardware using a genetic algorithm-based approach where adjacent qubits with two-qubit coupling connections have distinct colorings on the device graph to effectively cancel crosstalk.

Quantum error suppression is a technique used in quantum computing to minimize the impact of errors that occur during quantum operations. In particular, error suppression via dynamical decoupling can remove, for example, non-Markovian errors (e.g., quantum error processes where the future evolution of the system depends on its past interactions with the environment, leading to memory effects and correlations in error dynamics), crosstalk (e.g., unwanted interactions between qubits or quantum gates, where the operation on one qubit inadvertently affects neighboring qubits, leading to errors), and coherent errors (e.g., errors, often caused by consistent over-rotation or under-rotation during gate operations, leading to deterministic deviations from an intended quantum state) during quantum computations.

There exist various theoretically derived sequences, as well as schemes, to theoretically optimize DD sequences that consider various noise sources, quantum computation tasks, and imperfections in the implementation of the DD sequences. However, such theoretically derived sequences and schemes are not tailored to specific devices and are generally applied broadly to the device whenever idle gaps exist in the quantum circuit. Thus, such existing methods often perform poorly on real hardware, especially for dynamic circuits where multiple complex errors interact such that simple DD strategies perform poorly, and in some instances, worse than not applying DD at all. That is, unlike non-dynamic circuits, dynamic circuits tend to accumulate crosstalk and decoherence errors during feedforward periods. Moreover, measurement-induced control errors and measurement-induced collision errors are also unique to dynamic circuits which make error suppression with DD challenging. Accordingly, a low-overhead error suppression via DD method that can be applied to any combination of devices and dynamic circuits can be desireable.

Various embodiments of the present disclosure can be implemented to produce a solution to these problems. Embodiments described herein include systems, computer-implemented methods, and computer program products that enable multi-dimensional empirically adapted dynamical decoupling for dynamic circuits. In particular, various embodiments described herein can learn DD strategies that can be applied to any dynamic cirucit or non-dynamic circuit for a given device. Further, various embodiments described herein can do so with low-overhead by applying the DD strategies to any dynamic circuit or non-dynamic circuit for the given device without additional overhead for each circuit. Thus, the various embodiments described herein provide a new and more efficient approach to optimize DD that can be more effective and can reduce overhead.

In various embodiments, a dynamical decoupling component can be employed to enable multi-dimensional empirically adapted dynamical decoupling for dynamic circuits. For example, in various embodiments, the dynamical decoupling component can comprise an access component, a learning component, a graphing component, and an execution component. In various embodiments, the access component can obtain a graph (e.g., a device graph) of a quantum processor that represents qubit connectivity and collisions in the quantum processor. In various embodiments, the learning component can determine a first dynamical decoupling strategy for collision qubits in the quantum processor. For example, the learning component can determine the first dynamical decoupling strategy and by executing 2-dimensional GADD on a quantum circuit. Specifically, 2-dimensional GADD can involve applying different dynamical decoupling sequences based on locations of the qubits and statuses of the qubits. For instance, different dynamical decoupling sequences can be applied based on, for a particular time point, if qubits have a unitary status or a measured status and if qubits are in a collision with qubits that have a measured status. Furthermore, in various embodiments, the learning component can determine, based on the device graph of the quantum processor, a second dynamical decoupling strategy for non-collision qubits in the quantum processor. For example, the learning component can determine the second dynamical decoupling strategy by executing GADD on the device graph. In various embodiments, the learning component can additionally empirically learn the first dynamical decoupling strategy and the second dynamical decoupling strategy. Accordingly, the graphing component can apply the first dynamical decoupling strategy and the second dynamical decoupling strategy to the quantum circuit, and the execution component can perform the quantum circuit on the quantum processor.

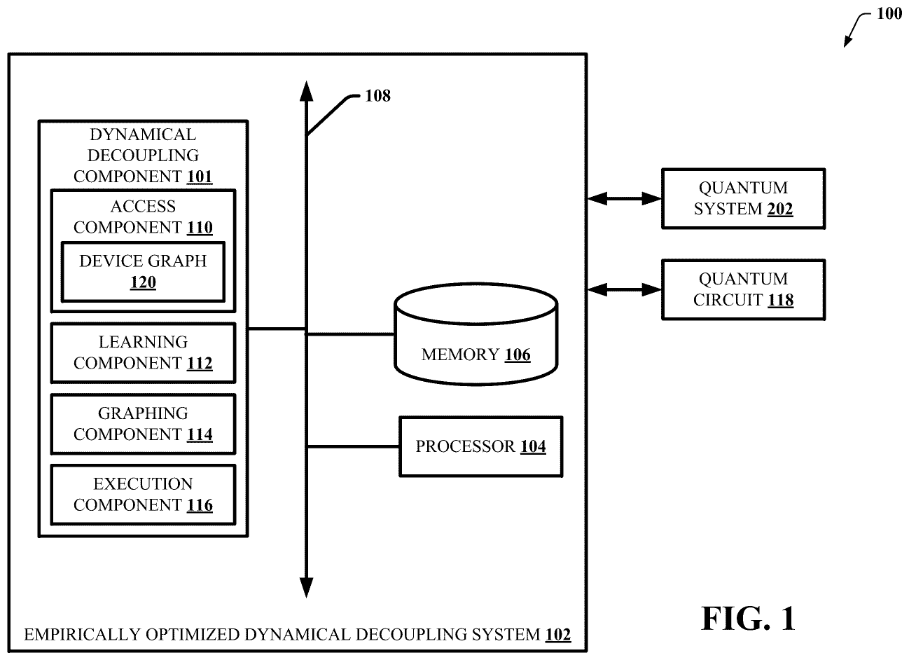

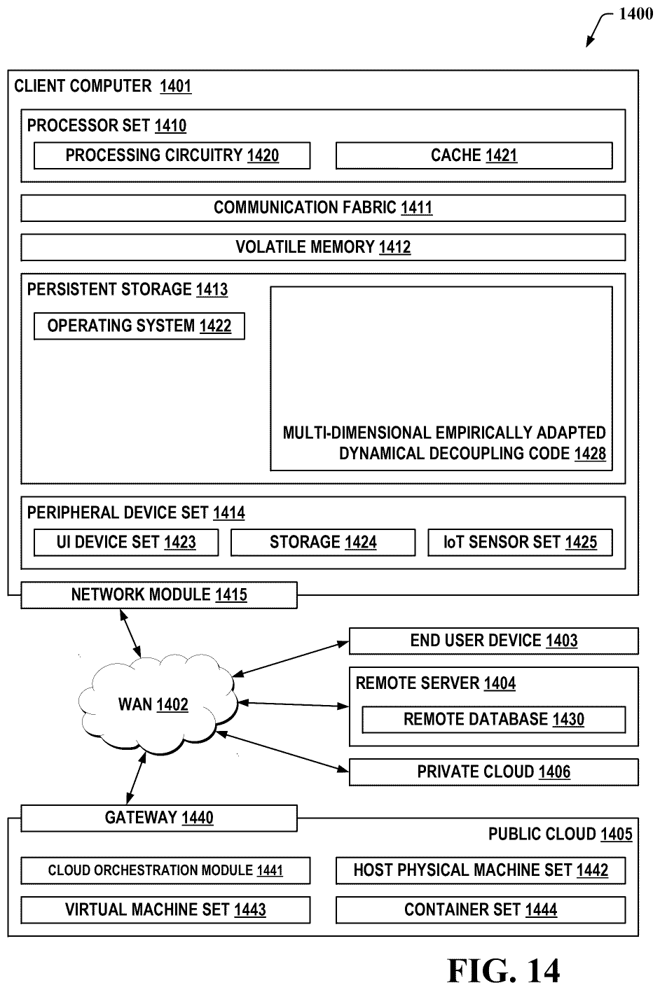

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate multi-dimensional empirically adapted dynamical decoupling for dynamic circuits in accordance with one or more embodiments described herein.

Non-limiting system 100 and/or the components of non-limiting system 100 can be employed to use hardware and/or software to solve problems that are highly technical in nature (e.g., related to quantum error suppression, dynamical decoupling, empirical learning of dynamical decoupling strategies, etc.), that are not abstract and that cannot be performed as a set of mental acts by a human. Further, some of the processes performed may be performed by specialized computers for carrying out defined tasks related to multi-dimensional empirically adapted dynamical decoupling. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the overhead involved in empirically optimizing dynamical decoupling strategies, improving and generalizing application of empirically optimized dynamical decoupling to any device and dynamic circuit pair, providing empirically optimized dynamical decoupling to dynamic circuits, etc.

Disclosed herein is a method for multi-dimensional empirically adapted dynamical decoupling, and the disclosed method can be applied to any target quantum circuit without additional overhead for a given device (e.g., a quantum processor). Additionally, the methods described herein can achieve improve fidelity over existing methods. Accordingly, the multi-dimensional empirically adapted dynamical decoupling procedure disclosed herein to facilitate quantum error suppression can represent a major advancement in the field of quantum error suppression.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., dynamical decoupling component 101, access component 110, learning component 112, graphing component 114, and/or execution component 116) to perform one or more actions. In one or more embodiments, memory 106 can store computer-executable components (e.g., dynamical decoupling component 101, access component 110, learning component 112, graphing component 114, and/or execution component 116).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

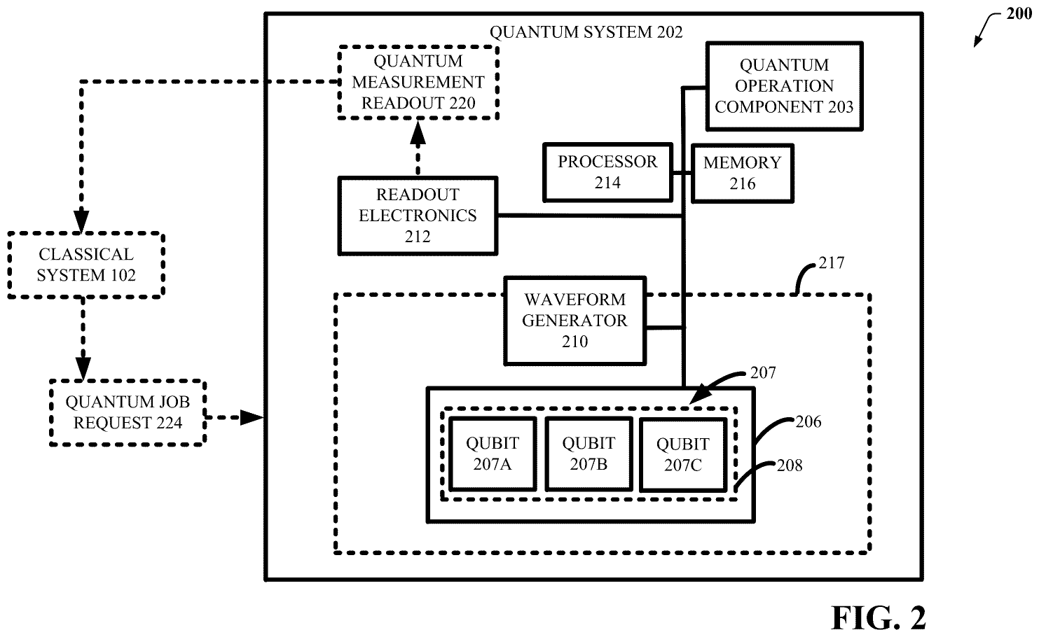

As illustrated in FIG. 1, non-limiting system 100 can comprise classical system 102 and quantum system 202. That is, the non-limiting system 100 can facilitate multi-dimensional empirically adapted dynamical decoupling, in combination with employment of the quantum system 202 (FIG. 2). Classical system 102 can be coupled (operatively, communicatively, electrically, and/or like function) to quantum system 202.

In various embodiments, dynamical decoupling component 101 can comprise access component 110, learning component 112, graphing component 114, and execution component 116.

The methods employed by dynamical decoupling component 101 to perform quantum error suppression can empirically optimize dynamical decoupling with context awareness by empirically learning DD strategies based on different measurement-induced errors. For example, learning component 112 can empirically learn the first dynamical decoupling strategy for qubits that exhibit measurement-induced collision errors, and can empirically learn the second dynamical decoupling strategy for qubits that exhibit measurement-induced control errors. Additionally, the methods employed by dynamical decoupling component 101 to perform quantum error suppression with empirically optimized dynamical decoupling can be applied to non-dynamic circuits and dynamic circuits.

Various embodiments described herein can be directed to the task of empirically learning DD strategies for collision qubits and non-collision qubits. To learn the first DD strategy and the second DD strategy, access component 110 can first obtain the device graph 120 of a device (e.g., quantum processor 214). In various aspects, the device graph 120 can indicate connectivity of the device and locations of collisions in the device. In other words, device graph 120 can indicate collision qubits in the device. In various embodiments, access component 110 can employ any suitable method to obtain the device graph 120.

For example, access component 110 can execute a calibration of qubits in the device to determine fundamental properties of the quantum device, such as the f₀₁ frequency (ground-to-first excited state transition frequency) and the f₁₂ frequency (first-to-second excited state transition frequency). Thereafter, by analyzing the difference between such transition frequencies and comparing them to an energy spectrum of neighboring qubits, collision qubits can be predicted.

As another example, access component 110 can empirically determine the collision qubits by performing a multi-qubit cross-mapping randomized benchmarking (mcm-rb) sweep across the device. By executing randomized quantum gate sequences and measuring the fidelity of multi-qubit operations with varying parameters (such as frequencies or drive strengths) during the mem-rb sweep, access component 110 can empirically detect when qubit collisions occur, based on drops in the fidelity of the quantum operations.

In one or more embodiments, learning component 112 can then learn the first DD strategy for collision qubits based on the identified collision qubits in the device graph 120. In various aspects, learning component 112 can learn the first DD strategy for collision qubits by performing 2-dimensional GADD. By employing 2-dimensional GADD, learning component 112 can learn a set of DD sequences based on statuses (e.g., measured status or unitary status) of the collision qubits and locations of the collision qubits. Learning DD sequences based on statuses and location of qubits can cancel measured-dependent measurement errors in addition to crosstalk.

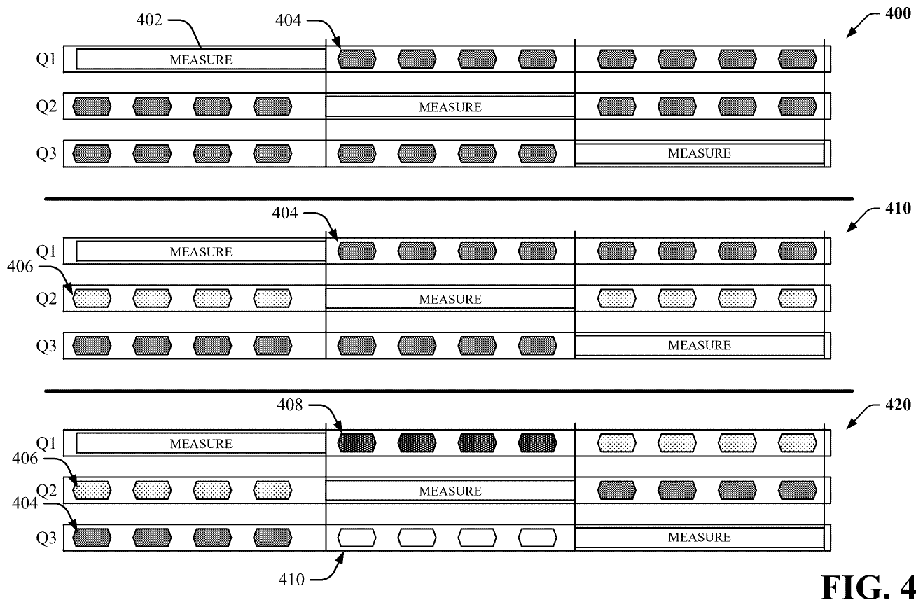

In one or more embodiments, learning component 112 can learn the second DD strategy for non-collision qubits. To empirically learn the second DD strategy for non-collision qubits, learning component 112 can perform 2-dimensional GADD on the device graph 120. The non-collision qubits can comprise qubits with measurement-induced control errors or qubits without significant measurement-induced errors. Additional details about 2-dimensional GADD are described with reference to FIG. 4.

After determining the first DD strategy for collision qubits and the second DD strategy for non-collision qubits, graphing component 114 can apply the first DD strategy and the second DD strategy to the quantum circuit 118. In various aspects, the quantum circuit 118 can be any desired target quantum circuit. That is, after learning the first DD strategy and the second DD strategy based on collision qubits and non-collision qubits in the device, graphing component 114 can apply the first DD strategy and the second DD strategy to any desired target quantum circuit to produce a corresponding error suppressed quantum circuit, and execution component 116 can execute the error suppressed quantum circuit on the device. This way, producing a corresponding error suppressed quantum circuit for any desired target quantum circuit can be achieved without additional overhead for relearning optimized DD strategies.

As illustrated at FIG. 2, the non-limiting system 200 can comprise a quantum system 202 that can be employed with or separate from the classical system 102.

Generally, the quantum system 202 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 220, can be responsive to the quantum job request 224 and associated input data and can be based at least in part on the input data, quantum functions and/or quantum computations.

In one or more embodiments, the quantum system 202 can comprise components, such as a quantum operation component 203, a quantum processor 206, pulse component 210 (e.g., a waveform generator) and/or a readout electronics 220 (e.g., readout component). In one or more other embodiments, the readout electronics 220 can be comprised at least partially by the classical system 102 and/or be external to the quantum system 202. The quantum processor 206 can comprise one or more, such as plural, qubits 207, organized into one or more quantum registers 208. Individual qubits 207A, 207B and 207C, for example, can be fixed frequency and/or single junction qubits, such as transmon qubits.

In one or more embodiments, a memory 216 and/or processor 214 can be associated with the quantum operation component 203, where suitable. The processor 214 can be any suitable processor. The processor 214 can generate one or more instructions for controlling the one or more processes of the quantum operation component 203.

The quantum operation component 203 can obtain (e.g., download, receive, search for and/or the like) a quantum job request 224 requesting execution of one or more quantum programs and/or a physical qubit layout. The quantum job request 224 can be provided in any suitable format, such as a text format, binary format and/or another suitable format. In one or more embodiments, the quantum job request 224 can be obtained by a component other than of the quantum system 202, such as a by a component of the classical system 102.

The quantum operation component 203 can determine mapping of one or more quantum logic circuits for executing a quantum program. In one or more embodiments, the quantum operation component 203 and/or quantum processor 206 can direct the waveform generator 210 to generate one or more pulses, tones, waveforms and/or the like to affect one or more qubits 207, such as in response to a quantum job request 224.

The waveform generator 210 can generally cause the quantum processor 206 to perform one or more quantum processes, calculations and/or measurements by creating a suitable electro-magnetic signal. For example, the waveform generator 210 can operate one or more qubit effectors, such as qubit oscillators, harmonic oscillators, pulse generators and/or the like to cause one or more pulses to stimulate and/or manipulate the state(s) of the one or more qubits 207 comprised by the quantum system 202.

The quantum processor 206 and a portion or all of the waveform generator 210 can be contained in a cryogenic environment, such as generated by a cryogenic environment 217, such as effected by a dilution refrigerator. Indeed, a signal can be generated by the waveform generator 210 to affect one or more of the plurality of qubits 207. Where the plurality of qubits 207 are superconducting qubits, cryogenic temperatures, such as about 4K or lower, can be employed for function of these physical qubits. Accordingly, one or more elements of the readout electronics 220 also can be constructed to perform at such cryogenic temperatures.

The readout electronics 220, or at least a portion thereof, can be contained in the cryogenic environment 217, such as for reading a state, frequency and/or other characteristic of qubit, excited, decaying or otherwise. In some embodiments, the readout electronics 220 can comprise readout resonators (e.g., readout resonators 706) that interact with the plurality of qubits 207 to, for example, measure their quantum states. For example, the plurality of qubits 207 can be multiplexed together on the readout resonators.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

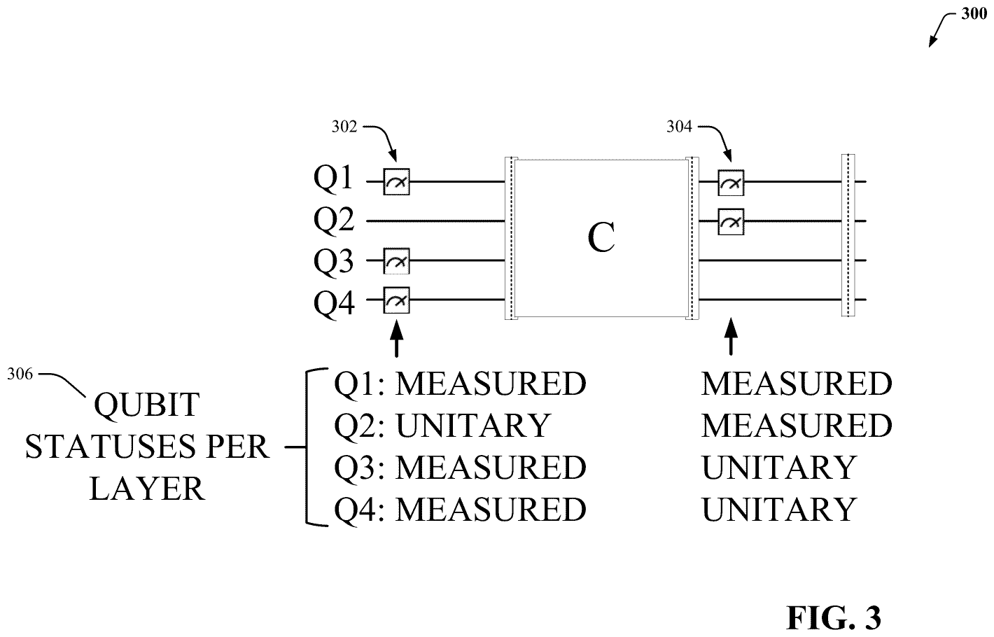

FIG. 3 illustrates a diagram of example, non-limiting dynamic circuit 300 in accordance with one or more embodiments described herein. Repetitive description of like elements and/or processes employed in respective embodiments is omitted for sake of brevity.

In various embodiments, dynamical decoupling component 101 can error suppress dynamic circuits with empirically optimized dynamical decoupling. For example, dynamical decoupling component 101 can receive quantum circuit 118, where quantum circuit 118 can be a dynamic circuit, such as non-limiting dynamic circuit 300.

As shown, non-limiting dynamic circuit 300 can comprise four qubits, denoted by Q1, Q2, Q3, and Q4. Further, non-limiting dynamic circuit 300 can undergo mid-circuit measurements. For example, non-limiting dynamic circuit 300 can undergo measurements at layer 302 and layer 302, wherein the layers occur at different time points. As shown by statuses 306, at layer 302, Q1, Q2, and Q3 can have a measured status. Also at layer 302, Q2 can have a unitary status At layer 304, though, Q1 and Q2 can have a measured status while Q2 and Q3 have a unitary stats. During the measurements at any layer, the non-limiting dynamic circuit 300 can be subject to measurement-induced control errors or measurement-induced collision errors between the qubits. The various embodiments described herein can be applied for error suppression of such measurement-induced errors by applying different DD sequences based on the statuses of the qubits for any layer or time point.

FIG. 4 illustrates diagrams of example, non-limiting genetic algorithm-based dynamical decoupling methods in accordance with one or more embodiments described herein. Repetitive description of like elements and/or processes employed in respective embodiments is omitted for sake of brevity.

As stated elsewhere herein, embodiments of the present disclosure can be employed for quantum error suppression to solve problems that address measurement-induced errors via multi-dimensional GADD (e.g., 2-dimensional GADD). In DD, a sequence of pulses can be applied at particular time intervals to a quantum circuit. Such sequence of pulses is applied at idle gaps in the quantum circuit 118 for a particular qubit. For example, during measurement 402 of a qubit (e.g., Q1), DD sequences can be applied to the other qubits during the idle gaps where the qubits are not being measured (e.g., Q2 and Q3).

In particular, non-limiting 2-dimensional GADD 420 can provide improved error suppression over non-limiting 0-dimensional DD 400. In non-limiting 0-dimensional DD 400, all qubits receive the same DD sequence, resulting in cancelling of single qubit errors. For example, the quantum circuit 118 can comprise three qubits (e.g., Q1, Q2, and Q3), where each of the three qubits receive the same DD sequence 404 at all idle gaps (e.g., period during which a qubit is not actively involved in any operation, such as a unitary gate application or measurement) in the quantum circuit 118.

Furthermore, non-limiting 2-dimensional GADD 420 can provide improved error suppression over non-limiting 1-dimensional GADD 410. In non-limiting 1-dimensional GADD 410, neighboring qubits receive different DD sequences, resulting in cancelling of crosstalk. For example, a qubit (e.g., Q3) can receive DD sequence 404 while a neighboring qubit (e.g., Q2) receives DD sequence 406, which is different from DD sequence 404.

To achieve this improvement over non-limiting 0-dimensional DD 400 and non-limiting 1-dimensional GADD 410, non-limiting 2-dimensional GADD 420 can apply different DD sequences based on locations of the qubits and statuses of the qubits, thereby cancelling measured-dependent measurement errors in addition to crosstalk. For example, as shown, non-limiting 2-dimensional GADD 420 can treat measurement-induced control errors as a separate case from measurement-induced collision errors, and thus apply DD sequence 408 and DD sequence 412 respectively based on the status and location of the qubits.

In various aspects, non-limiting 2-dimensional GADD 420 can thus mitigate device-specific and qubit-specific noise by applying the DD strategies (e.g., the first DD strategy and the second DD strategy) based on knowledge of where collisions occur on the device and knowledge of qubit pairs with measured and unitary statuses based on graph distance, such that adjacent qubits that are not colliding with measured qubits are assigned distinct DD sequences, which is obtained from device graph 120. Therefore, non-limiting 2-dimensional GADD 420 can extend upon existing crosstalk cancelation approaches by considering neighboring qubit pairs to be context-aware of which qubits have a measured status and a unitary status in each specific instance (e.g., time interval) where a DD sequence is applied.

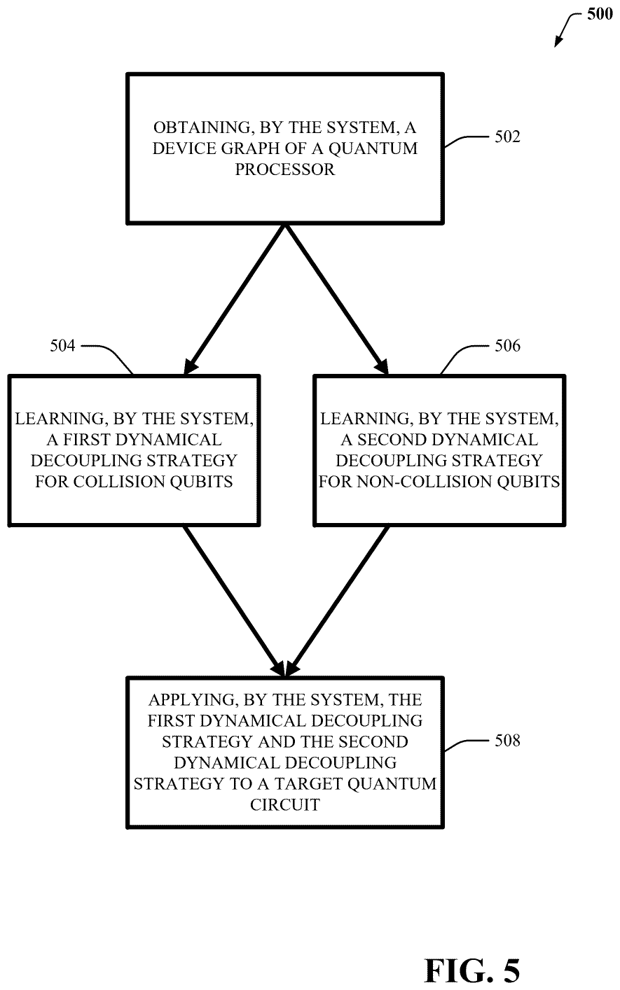

FIG. 5 illustrates a flow diagram of an example, non-limiting method 500 that can facilitate multi-dimensional empirically adapted dynamical decoupling for dynamic circuits in accordance with one or more embodiments described herein. Repetitive description of like elements and/or processes employed in respective embodiments is omitted for sake of brevity.

At 502, non-limiting method 500 can comprise obtaining (e.g., by access component 110), by a system operatively coupled to a processor, a device graph (e.g., device graph 120) of a quantum processor (e.g., processor 214). In various aspects, the device graph can be of any target quantum device that is to be used to execute quantum circuits on, and can indicate connectivity and collision qubits in the target quantum device.

At 504, non-limiting method 500 can comprise learning (e.g., by learning component 112), by the system, a first DD strategy for collision qubits.

At 506, non-limiting method 500 can comprise learning (e.g., by learning component 112), by the system, a second DD strategy for non-collision qubits. In various instances, the order in which the first DD strategy for collision qubits and the second DD strategy for non-collision qubits are determine is irrelevant.

At 508, non-limiting method 500 can comprise applying (e.g., by graphing component 114), by the system, the first DD strategy and the second DD strategy to a target quantum circuit (e.g., quantum circuit 118). In various embodiments, after determining the first DD strategy and the second DD strategy, which can each comprise a set of DD sequences based on the device graph for the given target quantum device, graphing component 114 can receive any target quantum circuit and apply the first DD strategy and the second DD strategy to produce a corresponding error suppressed quantum circuit. This allows error suppression via DD of any target quantum circuit for a given quantum device without any additional overhead from relearning DD sequences each time a different target quantum circuit is received.

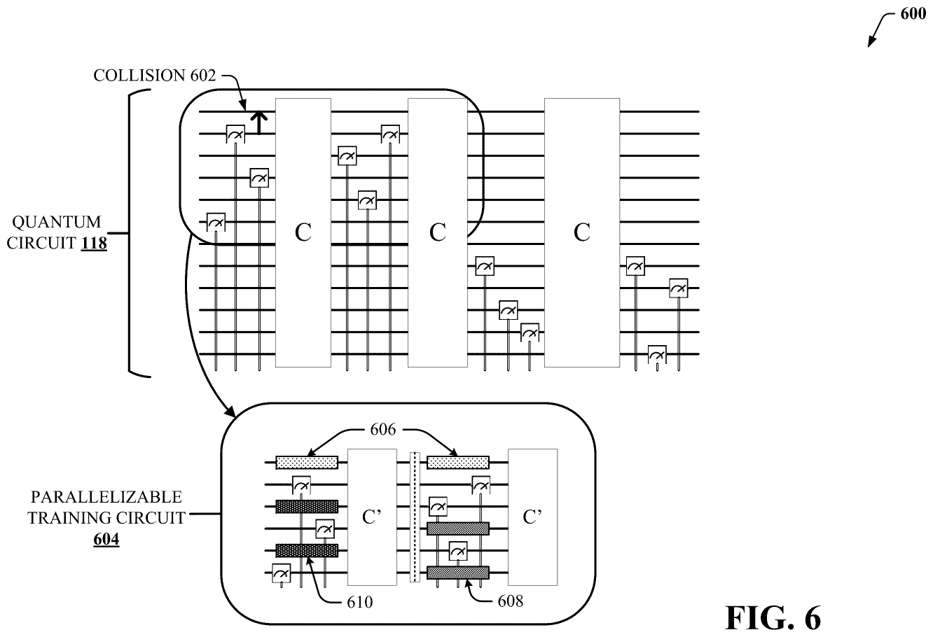

FIG. 6 illustrates a diagram of an example, non-limiting quantum circuit 600 with GADD on collision qubits in accordance with one or more embodiments described herein. Repetitive description of like elements and/or processes employed in respective embodiments is omitted for sake of brevity.

In various embodiments, as stated with reference to FIGS. 1 and 5, learning component 112 can determine the first DD strategy for collision qubits. Determination of the collision qubits can be obtained from the device graph 120. In various embodiments, learning component 112 can determine the first DD strategy for collision qubits using the non-limiting quantum circuit 600 as a parallelizable training circuit 604 that has a reduced depth. That is, learning component 112 can learn a set of DD sequences for collision qubits by running 2-dimensional GADD on the parallelizable training circuit 604. In various aspects, the parallelizable training circuit 604can be chosen to comprise desired relevant features. In various embodiments, the parallelizable training circuit 604 can be based on the set of qubits with a measured status and a unitary status for each layer of the parallelizable training circuit 604. For instance, learning component 112 can construct the parallelizable training circuit 604 based on qubit of interest (e.g., qubits involved in collisions). Further, learning component 112 can construct the parallelizable training circuit 604 by measuring on such relevant qubits while using idle gaps on the qubits with a unitary status as training intervals.

In various aspects, learning component 112 can thus learn any patterns (e.g., patterns in gates or measurements applied to qubits) in a target circuit, such as quantum circuit 118, using parallelizable training circuit 604. More specifically, learning component 112 can construct the parallelizable training circuit 604 based on such patterns in the target circuit. In other words, the patterns can be constructed into sub-circuits that can be used to construct the target circuit or the parallelizable training circuit 604. Accordingly, learning component 112 can construct parallelizable training circuit 604 to be the simplest possible circuit using the sub-circuits as building blocks. For example, as shown in FIG. 6, the parallelizable training circuit 604 is constructed by repeating the sub-circuit once.

In any case, learning component 112 can perform 2-dimensional GADD on the collision qubits to learn the first DD strategy. For instance, the first DD strategy can comprise collision DD sequence 606. Furthermore, the second DD strategy can comprise non-collision DD sequence 608 and non-collision DD sequence 610. As a non-limiting example, collision DD sequence 606 can be Z, X, I, Y, −Z, I, Y, −Y. As another non-limiting example, non-collision DD sequence 608 can be Z, Z, Z, −Z, I, I, X, −X. As yet another non-limiting example, non-collision DD sequence 610 can be I, X, −X, X, Y, I, Y, −X. Accordingly, learning component 112 can empirically optimize the set of DD sequences for the collision qubits in each idle gap.

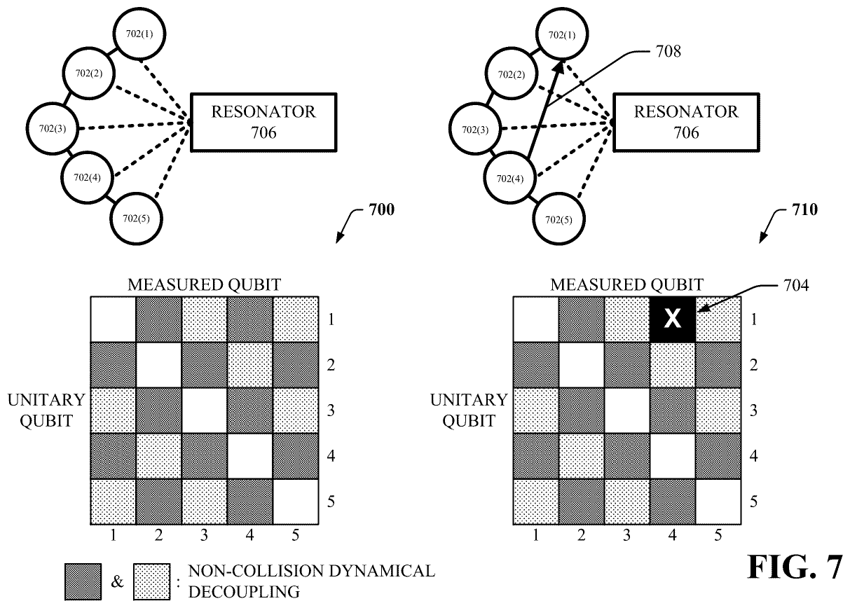

FIG. 7 illustrates diagrams of an example, non-limiting device graphs 700 and 710 associated with no collisions and unidirectional collisions in accordance with one or more embodiments described herein.

In various aspects, qubits 702 can be multiplexed together on a readout resonator 706. In some instances, qubits 702 can comprise any suitable number of qubits. That is, qubits 702 can comprise n qubits for any positive integer n: a qubit 702(1) to a qubit 702(n), wherein the n qubits are multiplexed together on readout resonator 706. For instance, a qubit 702(1) to a qubit 702(5) can be multiplexed together on readout resonator 706.

In various embodiments, after determining the first DD strategy for collision qubits and the second DD strategy for non-collision qubits, graphing component 114 can apply the first DD strategy and the second DD strategy to quantum circuit 118. That is, graphing component 114 can apply the first DD strategy and the second DD strategy based on the device graph 120 to apply DD based on status of the qubits 702 and locations of the qubits 702.

For example, in non-limiting device graph 700, in the case that there are no collisions (e.g., all qubits are non-collision qubits), graphing component 114 can apply one or more DD sequences from the second DD strategy to the qubits such that neighboring qubits do not have the same DD sequence.

As another example, in non-limiting device graph 710, in the case that there is a unidirectional collision (e.g., one qubit influences another without reciprocal effects), graphing component 114 can apply a DD sequence from the first DD strategy to the collision qubit. For instance, there can be a unidirectional collision 708, where qubit 702(4) has a measured status and qubit 702(1) has a unitary status, and wherein qubit 702(4) creates a measurement-induced collision error on qubit 702(1) (e.g., qubit 702(4) collides with qubit 702(1)). In such an instance, qubit 702(1) can be considered a collision qubit that is unitary. Accordingly, graphing component 114 can apply a DD sequence 704 from the first DD strategy on unitary qubit 702(1).

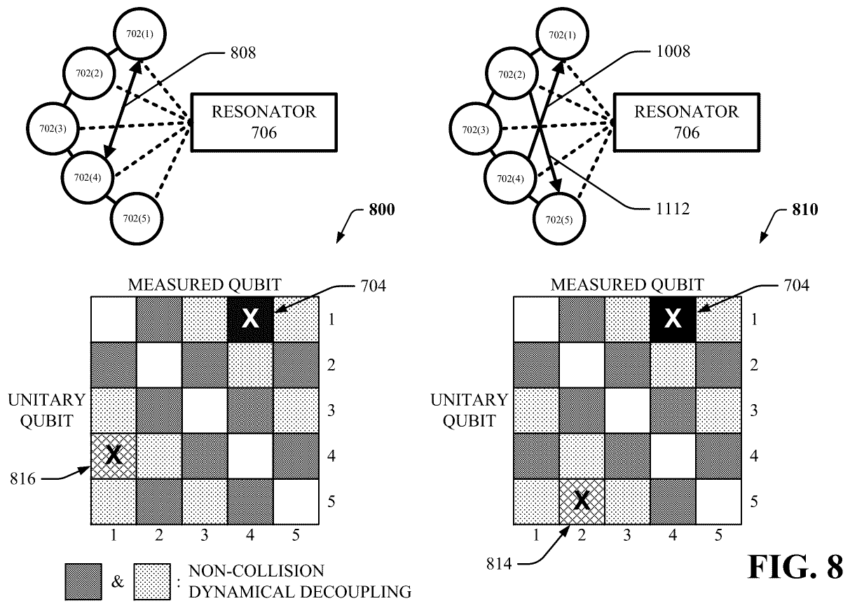

Now referring to FIG. 8, as yet another example, in non-limiting device graph 800, in the case that there is a bidirectional collision (e.g., mutual interactions between qubits, where each qubit affects the state of the other), graphing component 114 can apply a DD sequence from the first DD strategy to the collision qubits. For instance, there can be a bidirectional collision 808, where qubit 702(4) has a measured status, qubit 702(1) has a unitary status, and where qubit 702(4) collides with qubit 702(1). In such an instance, qubit 702(1) and qubit 702(4) can be considered collision qubits where qubit 702(1) is a unitary qubit and qubit 702(4) is a measured qubit. Accordingly, graphing component 114 can apply a DD sequence 704 from the first DD strategy on unitary qubit 702(1) and a DD sequence 816 from the first DD strategy on measured qubit 702(4). In various aspects, each of the qubits colliding with a measured qubit at a point in time can receive different DD sequences.

As still another example, in non-limiting device graph 810, in the case that there are multiple collisions, graphing component 114 can apply a DD sequence from the first DD strategy to the collision qubits. For instance, there can be a unidirectional collision 708 and a unidirectional collision 812 between qubit 702(2) and qubit 702(5), where qubit 702(2) has a measured status, qubit 702(5) has a unitary status. In such an instance, qubit 702(5) and qubit 702(1) can be considered collision qubits that are unitary qubits. Accordingly, graphing component 114 can apply a DD sequence 704 from the first DD strategy on unitary qubit 702(1) and a DD sequence 814 from the first DD strategy on unitary qubit 702(5). In various aspects, each of the qubits colliding with a measured qubit at a point in time can receive different DD sequences.

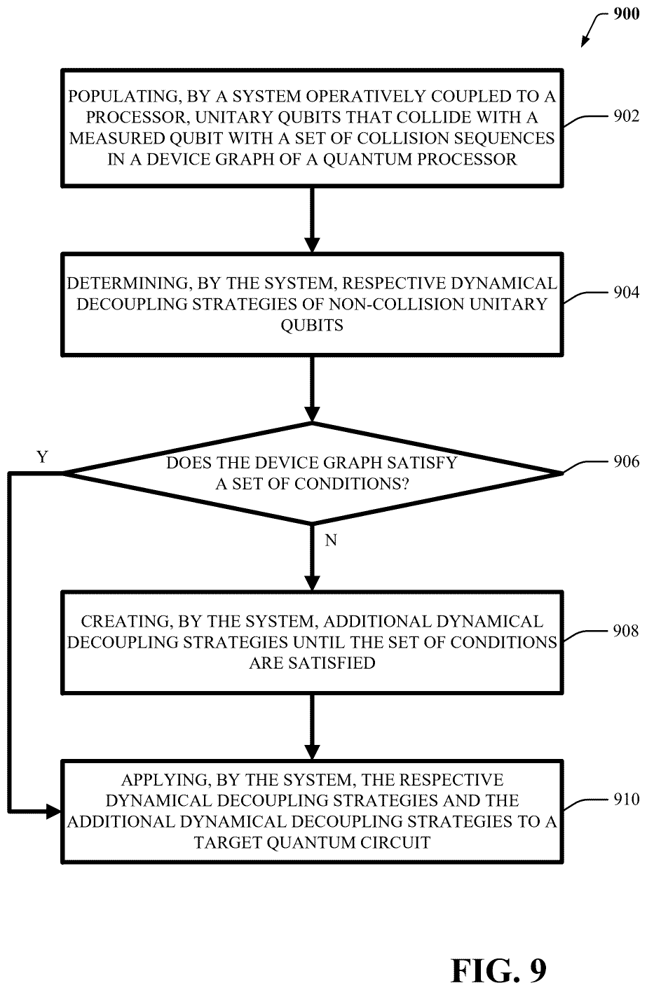

FIG. 9 illustrates flow diagrams of an example, non-limiting method 900 that can facilitate coloring of a device graph with 2-dimensional GADD in accordance with one or more embodiments described herein.

At 902, non-limiting method 900 can comprise populating (e.g., by graphing component 114), by a system operatively coupled to a processor, unitary qubits that collide with a measured qubit with a set of collision sequences in a device graph (e.g., device graph 120) of a quantum processor (e.g., processor 214). In other words, if a qubit with a measured status collides with a qubit with a unitary status, graphing component 114 can assign the qubit with the unitary status a DD sequence from the first DD strategy in the device graph (e.g., in the DD coloring of the device graph).

At 904, non-limiting method 900 can comprise determining (e.g., by graphing component 114), by the system, respective dynamical decoupling strategies of non-collision unitary qubits. In particular, graphing component 114 can assign respective DD sequences from the second DD strategy for each non-collision qubit with a unitary status in the device graph.

At 906, non-limiting method 900 can comprise determining if the device graph satisfies a set of conditions. If yes (e.g., the device graph satisfies a set of conditions), non-limiting method 900 can proceed to 910. If no (e.g., the device graph does not satisfy a set of conditions), non-limiting method can proceed to 908. In various aspects, the set of conditions can specify a particular configuration of the DD sequences to be applied to each qubit in each idle gap. Specifically, the set of conditions can restrain neighboring qubits to have different DD sequences. Further, imposing the set of conditions on the device graph such that neighboring qubits have different DD sequences can minimize crosstalk.

At 908, non-limiting method 900 can comprise creating (e.g., by graphing component 114), by the system, additional dynamical decoupling sub-strategies from the second dynamical decoupling strategy until the set of conditions are satisfied. For example, graphing component 114 can create the additional DD sub-strategies until all neighboring qubits have different DD sequences.

At 910, non-limiting method 900 can comprise applying (e.g., by graphing component 114), by the system, the respective dynamical decoupling strategies and the additional dynamical decoupling sub-strategies from the second dynamical decoupling strategy to a target quantum circuit (e.g., quantum circuit 118).

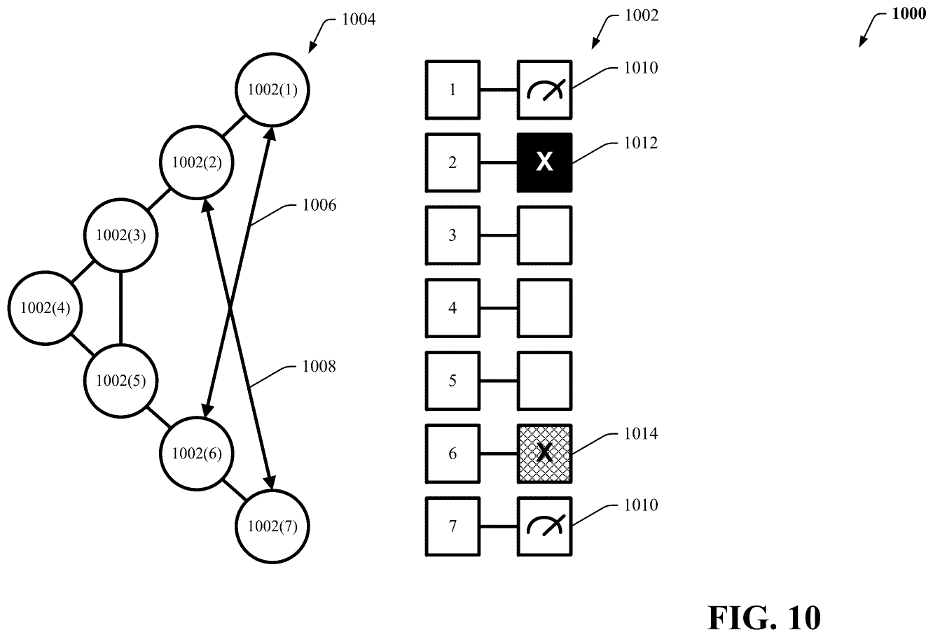

In various aspects, non-limiting method 900 can be implemented when qubits in a quantum device comprise a complex connectivity to generalize the workflow to such complex scenarios. A non-limiting example is described with respect to FIGS. 10-12. Furthermore, non-limiting method 900 can be implemented to determine an optimized DD strategy based on collision qubits and non-collision qubits for any point in time in the quantum circuit 118 (e.g., at each idle gap in the quantum circuit).

FIG. 10-12 illustrate diagrams of example, non-limiting device graphs 1000, 1100, and 1200 with multi-dimensional GADD in accordance with one or more embodiments described herein.

Further illustrated in FIGS. 10-12 is a non-limiting example of generalizing empirically optimized DD for dynamic circuits to more complex quantum devices. As a non-limiting example, a target quantum device can comprise qubit connectivity 1004, comprising qubits 1002. That is, there can be an n-qubits unit for any suitable positive integer n: a qubit 1002(1) to a qubit 1002(7). As an example of complex connectivity of qubits 1002, three qubits can be triangularly connected, such as qubit 1002(4), qubit 1002(3), and qubit 1002(5).

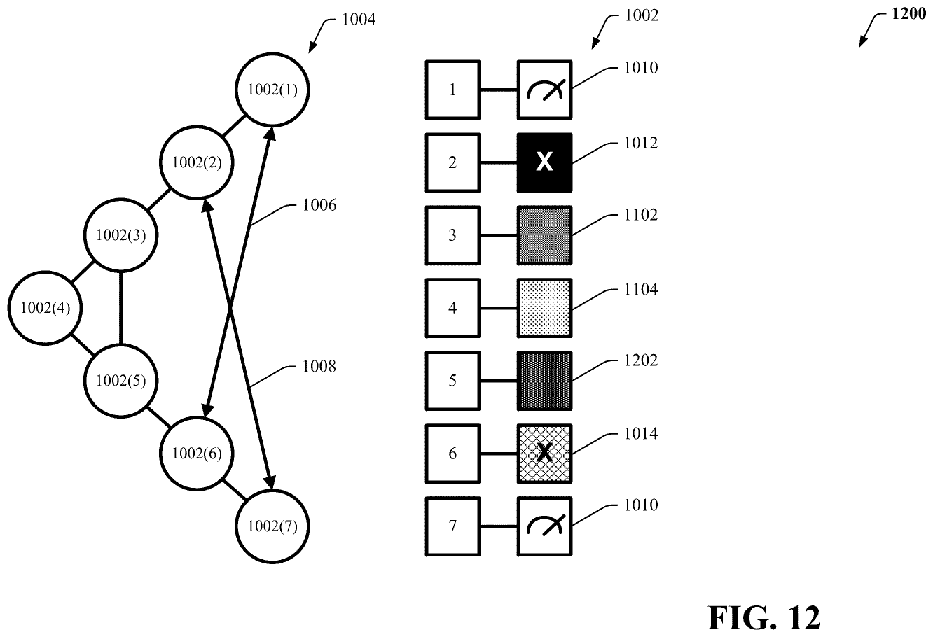

Furthermore, there can be a collision 1006 and a collision 1008. More specifically, qubit 1002(1) can have a measured status 1010, qubit 1002(7) can have a measured status, and the remaining qubits of qubits 1002 can have a unitary status. Qubit 1002(1) can collide with qubit 1002(6) and qubit 1002(7) can collide with qubit 1002(2). Accordingly, with reference to FIG. 12, graphing component 114 can populate the qubits with a unitary status with a set of collision sequences in device graph 1003. For instance, graphing component 114 can assign the qubit 1002(2) with DD sequence 1012, where DD sequence 1012 can be learned in the first DD strategy. Further, graphing component 114 can assign the qubit 1002(6) with DD sequence 1014, where DD sequence 1014 can also be learned in the first DD strategy.

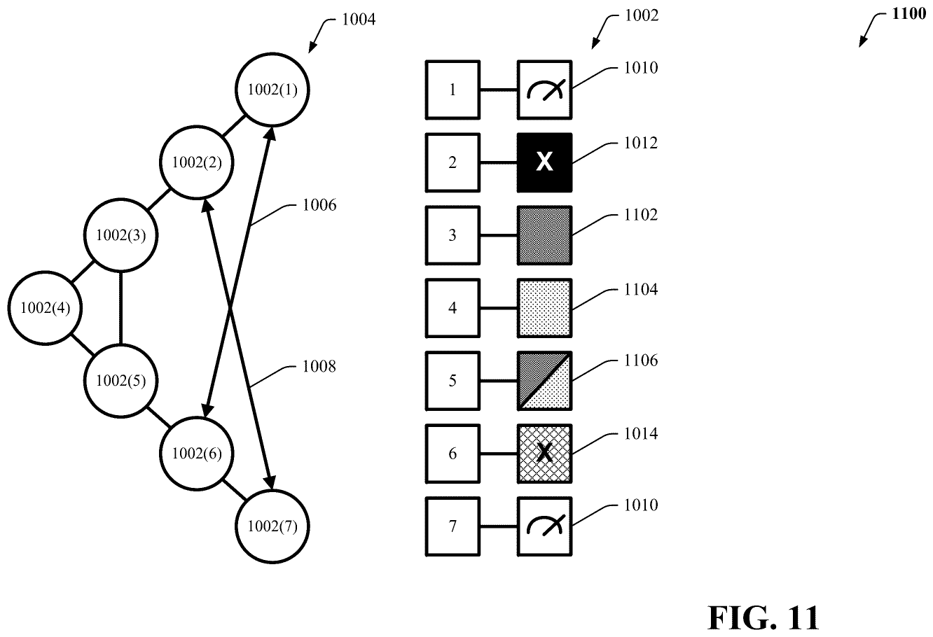

Thereafter, referencing FIG. 11, graphing component 114 can determine respective DD sequences of the non-collision qubits of unitary status such that neighboring qubits have different DD sequences. In various aspects, the respective DD sequences can be learned in the second DD strategy. However, in some cases such as complex devices, ensuring all neighboring qubits have a different DD sequence can be impossible. For example, in a DD coloring with two colors for the device graph 1003, graphing component 114 can assign qubit 1002(3) with DD sequence 1102 and qubit 1002(4) with DD sequence 1104. As such, qubit 1002(5) will not satisfy such condition for neighboring qubits to have different DD sequences due to the qubit connectivity 1004, as shown by 1406.

Accordingly, with reference to FIG. 12, graphing component 114 can create an additional DD sub-strategy from the second DD strategy to satisfy the conditions. For instance, graphing component 114 can create an additional DD sequence 1202 to satisfy the condition that adjacent qubits are assigned distinct DD sequences. More specifically, the unitary qubits not in collision 1006 or collision 1008 (e.g., qubit 1002(3), qubit 1002(4), and qubit 1002(5)), for this particular time point, can thus have distinct DD strategies after creating the additional sub-strategy (e.g., DD sequence 1202) from the second dynamical decoupling strategy. Further, although qubit 1002(6) is adjacent to qubit 1002(5) and qubit 1002(2) is adjacent to qubit 1002(3), since qubit 1002(6) and qubit 1002(2) are involved in collision 1006 and collision 1008, they are assigned DD sequences from the first DD strategy. Thus, their assigned DD sequences are distinct from that of qubit 1002(6) and qubit 1002(2). Note that, this is a non-limiting example and graphing component 114 can create any suitable number of DD sequences to satisfy the set of conditions. Furthermore, this process can be repeated for each time step in the quantum circuit 118. In any case, once the set of conditions are satisfied, execution component 116 can perform the quantum circuit 118 with the determined DD strategies at each time step on the quantum processor 214.

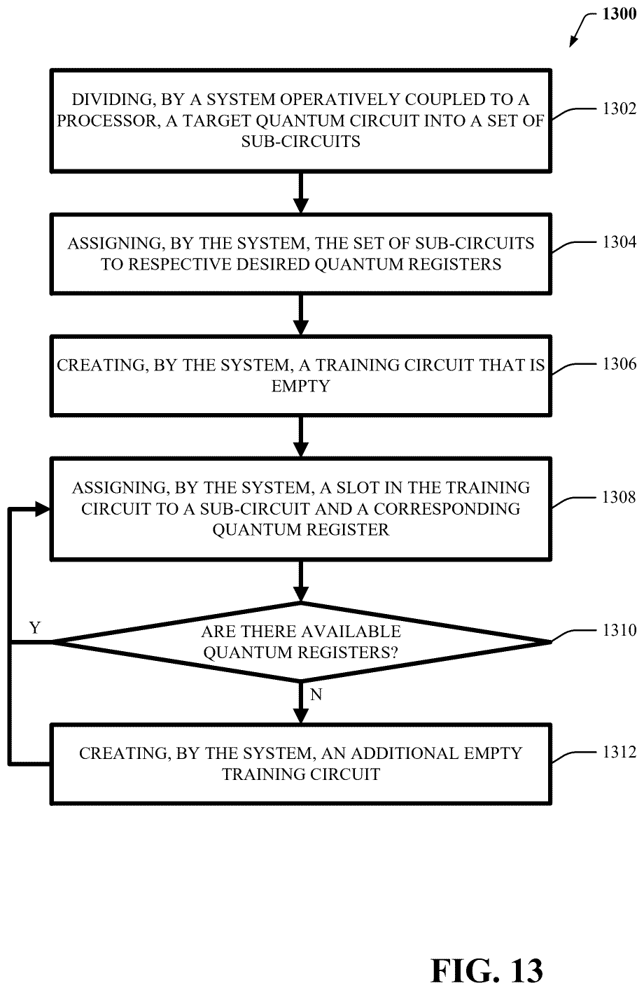

FIG. 13 illustrates flow diagrams of an example, non-limiting method 1300 that can facilitate training for multi-dimensional GADD in a parallelized manner that reduces the depth of training circuits in accordance with one or more embodiments described herein.

At 1302, non-limiting method 1300 can comprise dividing (e.g., by learning component 112), by a system operatively coupled to a processor, a target quantum circuit (e.g., quantum circuit 118) into a set of sub-circuits (e.g., DD motifs).

At 1304, non-limiting method 1300 can comprise assigning (e.g., by learning component 112), by the system, the set of sub-circuits to respective desired quantum registers (e.g., quantum registers 208). For example, non-limiting method 1300 can further comprise identifying which sub-circuits are qubit-dependent. Thereafter, learning component 112 can assign the sub-circuits that are qubit-dependent to a desired set of quantum registers. In various aspects, learning component 112 can assign each sub-circuit to a set of quantum registers.

At 1306, non-limiting method 1300 can comprise creating (e.g., by learning component 112), by the system, a training circuit that is empty.

At 1308, non-limiting method 1300 can comprise assigning (e.g., by learning component 112), by the system, a slot in the training circuit to a sub-circuit and a corresponding quantum register.

At 1310, non-limiting method 1300 can comprise determining if there are available quantum registers in the training circuit. If yes (e.g., there are available quantum registers in the training circuit), non-limiting method 1300 can proceed to 1308. If no (e.g., there are no available quantum registers in the training circuit), non-limiting method can proceed to 1312.

At 1312, non-limiting method 1300 can comprise creating (e.g., by learning component 112), by the system, an additional training circuit that is empty.

Although not pictured, non-limiting method 1300 can further comprise assigning slots in the training circuit to sub-circuits that are qubit-independent. In various cases, learning component 112 can first assign slots to sub-circuits that are qubit-dependent, and then assign sub-circuits that are qubit-independent after.

For example, learning component 112 can divide quantum circuit 118 into sub-circuits C₁, C₂, . . . , Cₙ for any suitable positive integer n. Further, in various aspects, learning component 112 can assign a desire set of quantum registers Rₙ to each sub-circuit Cᵢ, where Rₙ⊂QR and where QR denotes the set of all available quantum registers (e.g., quantum registers 208). In some cases, learning component 112 can assign the sub-circuit a desired set of quantum registers if the sub-circuit is qubit-dependent. In other cases, learning component 112 can assign an empty set Ø if the sub-circuit is qubit-independent. After creating an empty training circuit, for each pair of sub-circuit and corresponding quantum register (Cᵢ, Rᵢ), learning component 112 can assign a slot in the training circuit to the pair (Cᵢ, Rᵢ). For each pair (Cᵢ, Rᵢ), if there are available quantum registers, learning component 112 can move to the next Cᵢ. Conversely, if there are no available quantum registers, learning component 112 can create an additional training circuit. After assigning each sub-circuit with a desired set of quantum registers to the one or more training circuits, learning component can assign slots in the one or more training circuits to the sub-circuits assigned to the empty set. To implement this step, learning component 112 can assign a slot in the one or more training circuits to each quantum register Rᵢ by choosing the first available set of quantum registers. Similarly, if there are no available quantum registers in the one or more training circuits, learning component 112 can create an additional training circuit.

In various embodiments, non-limiting method 1300 can be implemented to parallelize the learning process of the first DD strategy and the second DD strategy on the quantum processor by iteratively creating training circuits from sub-circuits of a target quantum circuit, thereby improving the processing efficiency to learn empirically optimized DD strategies.

FIG. 14 illustrates a block diagram of an example, non-limiting, operating environment 1400 in which one or more embodiments described herein can be facilitated. FIG. 14 and the following discussion are intended to provide a general description of a suitable operating environment 1400 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as multi-dimensional empirically adapted dynamical decoupling code 1428. In addition to block 1428, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1414), communication fabric 1411, volatile memory 1412, persistent storage 1413 (including operating system 1422 and block 1428, as identified above), peripheral device set 1421 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

PROCESSOR SET 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1414 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits and performing quantum computing.

Computer-readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1414 and the other storage media discussed below. The program instructions, and associated data, are accessed by processor set 1410 to control and direct performance of the inventive methods. In computing environment 1400, at least some of the instructions for performing the inventive methods may be stored in block 1428 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid state storage devices. Operating system 1422 may take several forms, such as various known proprietary operating systems or open source Portable Operating System Interface-type operating systems that employ a kernel. The code included in block 1428 typically includes at least some of the computer code involved in performing the inventive methods.

PERIPHERAL DEVICE SET 1421 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In some embodiments, storage 1424 may take the form of a quantum computing storage device for storing data in the form of qubits. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

NETWORK MODULE 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer-readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401), and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

REMOTE SERVER 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud.

CLOUD COMPUTING SERVICES AND/OR MICROSERVICES (not separately shown in FIG. 14): private and public clouds 1406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
obtains a graph of a quantum processor that represents qubit connectivity and collisions in the quantum processor;
determines a first dynamical decoupling strategy for collision qubits;
determines, based on the graph of the quantum processor, a second dynamical decoupling strategy for non-collision qubits through empirical learning; and
applies the first dynamical decoupling strategy and the second dynamical decoupling strategy to a quantum circuit; and
performs the quantum circuit on the quantum processor.

2. The system of claim 1, wherein at least one of the computer executable components further:
applies the first dynamical decoupling strategy and the second dynamical decoupling strategy to the quantum circuit based on colliding qubit properties or non-colliding qubit properties at idle gaps in the quantum circuit.

3. The system of claim 1, wherein at least one of the computer executable components further:
populates unitary qubits that collide with a measured qubit with a set of collision sequences in the graph.

4. The system of claim 1, wherein at least one of the computer executable components further:
determines respective dynamical decoupling sequences of the non-collision qubits that have unitary statuses for a particular time point, wherein the respective dynamical decoupling sequences of the non-collision qubits that have unitary statuses are different from dynamical decoupling sequences of neighboring non-collision qubits.

5. The system of claim 4, wherein at least one of the computer executable components further:
determines if the graph satisfies a set of conditions based on the respective dynamical decoupling sequences of the non-collision qubits that are unitary qubits, wherein the set of conditions assert that, for any time point, unitary qubits in a collision with one or more measured qubits have corresponding collision dynamical decoupling sequences applied and unitary qubits that are not in a collision with the one or more measured qubits have distinct dynamical decoupling strategies from adjacent qubits applied.

6. The system of claim 5, wherein at least one of the computer executable components further:
creates additional dynamical decoupling sub-strategies from the second dynamical decoupling strategy until the set of conditions are satisfied.

7. The system of claim 1, wherein at least one of the computer executable components further:
determines the first dynamical decoupling strategy for collision qubits based on unidirectional collisions, bidirectional collisions, or multiple collisions, wherein the first dynamical decoupling strategy consists of respective dynamical decoupling sequences for each collision qubit.

8. The system of claim 1, wherein determining the first dynamical decoupling strategy or the second dynamical decoupling strategy comprises:
empirically learning dynamical decoupling strategies on the quantum circuit by constructing a plurality of training circuits from the quantum circuit, wherein the dynamical decoupling strategies are applicable to any qubit pairs in the quantum circuit.

9. The system of claim 8, wherein constructing the plurality of training circuits comprises:
dividing the quantum circuit into sub-circuits; and
iteratively creating the plurality of training circuits using the sub-circuits.

10. The system of claim 9, wherein iteratively creating the plurality of training circuits using the sub-circuits comprises:
identifying a subset of the sub-circuits that are qubit-dependent;
assigning the subset of the sub-circuits that are qubit-dependent to a respective set of quantum registers;
assigning slots in the plurality of training circuits to the sub-circuits that are qubit-dependent and the respective set of quantum registers; and
assigning slots in the plurality of training circuits to sub-circuits that are qubit-independent and a first available set of quantum registers.

11. The system of claim 10, wherein iteratively creating the plurality of training circuits using the sub-circuits further comprises:
creating an additional training circuit if there are no available quantum registers in the plurality of training circuits.

12. A computer-implemented method, comprising:
obtaining, by a system operatively coupled to a processor, a graph of a quantum processor that represents qubit connectivity and collisions in the quantum processor;
determining, by the system, a first dynamical decoupling strategy for collision qubits;
determining, by the system and based on the graph of the quantum processor, a second dynamical decoupling strategy for non-collision qubits through empirical learning;
applying, by the system, the first dynamical decoupling strategy and the second dynamical decoupling strategy to a quantum circuit; and
performing the quantum circuit on the quantum processor.

13. The computer-implemented method of claim 12, further comprising:
applies, by the system, the first dynamical decoupling strategy and the second dynamical decoupling strategy to the quantum circuit based on colliding qubit properties or non-colliding qubit properties at idle gaps in the quantum circuit.

14. The computer-implemented method of claim 12, further comprising:
populating, by the system, unitary qubits that collide with a measured qubit with a set of collision sequences in the graph.

15. The computer-implemented method of claim 12, further comprising:
determining, by the system, respective dynamical decoupling sequences of non-collision qubits that have unitary statuses for a particular time point, wherein the respective dynamical decoupling sequences of the non-collision qubits that have unitary statuses are different from dynamical decoupling sequences of neighboring non-collision qubits.

16. The computer-implemented method of claim 12, further comprising:
determining, by the system, if the graph satisfies a set of conditions based on the respective dynamical decoupling sequences of the non-collision qubits that are unitary qubits, wherein the set of conditions assert that, for any time point, unitary qubits in a collision with one or more measured qubits have corresponding collision dynamical decoupling sequences applied and unitary qubits that are not in a collision with the one or more measured qubits have distinct dynamical decoupling strategies from adjacent qubits applied; and
creating, by the system, additional dynamical decoupling sub-strategies from the second dynamical decoupling strategy until the set of conditions are satisfied.

17. The computer-implemented method of claim 16, determining the first dynamical decoupling strategy or the second dynamical decoupling strategy comprises:
empirically learning dynamical decoupling strategies on the quantum circuit by constructing a plurality of training circuits from the quantum circuit, wherein the dynamical decoupling strategies are applicable to any qubit pairs in the quantum circuit.

18. The computer-implemented method of claim 17, wherein constructing the plurality of training circuits comprises:
dividing the quantum circuit into sub-circuits; and
iteratively creating the plurality of training circuits using the sub-circuits.

19. A computer program product for multi-dimensional empirically adapted dynamical decoupling for dynamic circuits, the computer program product comprising a computer readable storage medium having program instructions embodied therewith, the program instructions executable by a processor to cause the processor to:
obtain a graph of a quantum processor that represents qubit connectivity and collisions in the quantum processor;
determine a first dynamical decoupling strategy for collision qubits;
determine, based on the graph of the quantum processor, a second dynamical decoupling strategy for non-collision qubits through empirical learning;
apply the first dynamical decoupling strategy and the second dynamical decoupling strategy to a quantum circuit; and
perform the quantum circuit on the quantum processor.

20. The computer program product of claim 19, wherein determining the first dynamical decoupling strategy or the second dynamical decoupling strategy comprises:
empirically learning dynamical decoupling strategies on the quantum circuit by constructing a plurality of training circuits from the quantum circuit, wherein the dynamical decoupling strategies are applicable to any qubit pairs in the quantum circuit.
